(19) United States
(12) Patent Application Publication
(10) Pub. No.: US 2004/0229021 A1
(43) Pub. Date: Nov. 18, 2004

(54) Attachment piece in combination with a diagram/letter-printed article

(75) Inventor: Sen-Mei Cheng, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: TAIWAN PAIHO LIMITED

(21) Appl. No.: 10/436,193

(22) Filed: May 13, 2003

(51) Int. Cl. B32B 3/00

(52) U.S. Cl. 428/195.1

(57) ABSTRACT

An attachment piece in combination with a diagram/letter-printed article is mainly made up of an attachment piece heat-melted fastened to the top surface of a diagram/letter-printed article wherein the diagram/letter-printed article has a base layer of a woven fabric, cloth, leather, or something of the like with diagrams or letters printed at the top surface thereon. The attachment piece is made up of a transparent plastic film with a layer of transparent adhesive glue coated at one side thereof, and a layer of bead-like and transparent glass particles embedded on top of the transparent plastic film via the transparent adhesive glue thereof. In case of a dark place or nighttime, the attachment piece combined with the diagram/letter-printed article can reflect light beams sending out from a light source via the bead-like and transparent glass particles thereof to give out warning signals, while, under normal light, the bead-like and transparent glass particles thereof can penetrably reveal the diagrams or letters of the diagram/letter-printed article thereof.

### BACKGROUND OF THE INVENTION

The present invention is related to an attachment piece in combination with a diagram/letter-printed article, mainly made up of an attachment piece heat-melted fastened to the top surface of a diagram/letter-printed article of a woven fabric, cloth, leather, or something of the like with diagrams or letters embedded therein. The attachment piece has a transparent plastic film with a layer of transparent adhesive glue coated at one side thereof, and a layer of bead-like and transparent glass particles embedded on top of the transparent plastic film via the transparent adhesive glue thereof. In case of a dark place or nighttime, the attachment piece combined with the diagram/letter-printed article can reflect light beams sending out from a light source via the bead-like and transparent glass particles thereof to give out warning signals for safety thereof, while, under normal light, the bead-like and transparent glass particles thereof can penetrably reveal the diagrams or letters embedded therein.

A conventional attachment piece is usually made up of a transparent film without any reflective designs. And a conventional reflective article such as reflective paint, a reflective plate, or a reflective banner is impenetrably provided with the only function of reflection, through which no diagrams or letters can be revealed. For a reflective article with diagrams or letters printed thereon, the diagrams or letters are revealed under normal light. But in case of a dark place or nighttime, the reflective article reduced in reflective area by the diagrams or letters printed thereon may fail to effectively reflect light beams sending out from a light source. Besides, the diagrams or letters printed on the surface thereof can easily come off or worn out of recognition.

### SUMMARY OF THE PRESENT INVENTION

It is, therefore, the primary purpose of the present invention to provide an attachment piece in combination with a diagram/letter-printed article wherein the attachment piece, made up of a transparent plastic film with bead-like and transparent glass particles embedded thereon via a layer of transparent adhesive glue, can effectively reflect light beams sending out from a light source via the bead-like and transparent glass particles to give out warning signals in case of a dark place or nighttime, as well as penetrably reveal diagrams or letters disposed on the top surface of the diagram/letter-printed article under normal light.

It is, therefore, the secondary purpose of the present invention to provide an attachment piece in combination with a diagram/letter-printed article wherein the attachment piece is heat-melted fastened to the top surface of the diagram/letter-printed article to embed the diagrams or letters therein so as to penetrably reveal as well as safely protect the diagrams or letters thereof without the danger of coming off or being worn out of recognition.

### BRIEF DESCRIPTION OF THE DRAWINGS

FIG. 1 is a perspective exploded view of the present invention.

FIG. 2 is a perspective view of the present invention in assembly.

FIG. 3 is a sectional view of the present invention in assembly.

FIG. 4 is a diagram showing the light shedding from a light source being reflected by the present invention in a dark place or at nighttime.

### DETAILED DESCRIPTION OF THE PREFERRED EMBODIMENTS

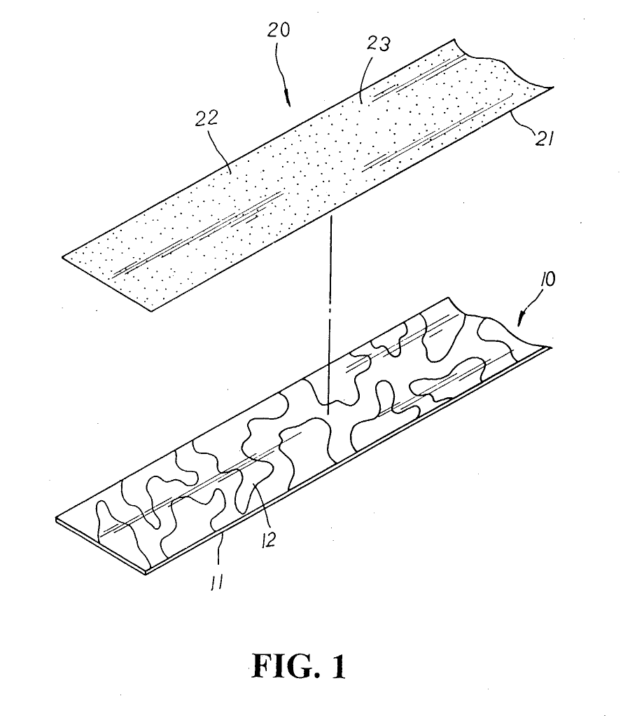

Please refer to FIG. 1. The present invention is related to an attachment piece in combination with a diagram/letter-printed article, comprising a diagram/letter-printed article 10 and an attachment piece 20. The diagram/letter-printed article 10 has a base layer 11 of a woven fabric, cloth, leather, or something of the like with diagrams or letters 12 printed at the top surface thereon. The attachment piece 20 is made up of a transparent plastic film 21, a layer of transparent adhesive glue 22 coated at one side of the transparent plastic film 21 thereof, and a layer of bead-like and transparent glass particles 23 embedded on top of the transparent plastic film 21 via the transparent adhesive glue 22 thereof.

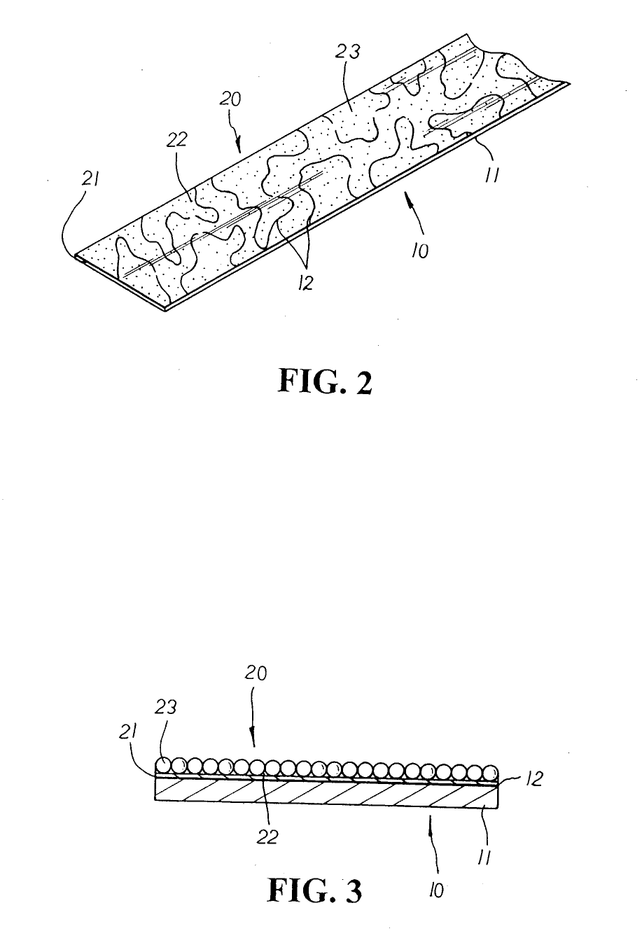

Please refer to FIGS. 2, 3. The transparent plastic film 21 of the attachment piece 20 with the transparent adhesive glue 22 coated at one side thereof is applied to the top surface of the base layer 11 of the diagram/letter-printed article 10 with diagrams or letters 12 disposed thereon. The attachment piece 20 and the diagram/letter-printed article 10 are then heat-melted fastened into one integral piece with the diagrams or letters 12 thereof embedded therein. The diagrams or letters 12 thereof are penetrably revealed as well as safely protected by the transparent plastic film 21 and the bead-like transparent glass particles 23 thereof without the danger of coming off to complete the assembly of the present invention.

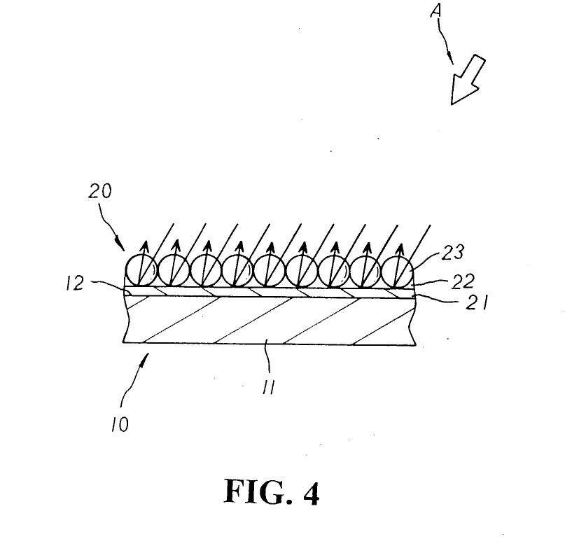

Please refer to FIG. 4. In case of a dark place or nighttime, the attachment piece 20 combined with the diagram/letter-printed article 10 can reflect light beams sending out from a light source A via the bead-like and transparent glass particles 23 thereof to give out warning signals for safety thereof. Meanwhile, under normal light, the bead-like and transparent glass particles 23 thereof can penetrably reveal the diagrams or letters 12 disposed at the diagram/letter-printed article 10 thereon.

What is claimed is:

1. An attachment piece in combination with a diagram/letter-printed article, comprising an attachment piece heat-melted fastened into a diagram/letter-printed article with diagrams or letters embedded therein, being characterized by that:
the attachment piece being made up of a transparent plastic film, a layer of transparent adhesive glue coated at one side of the transparent plastic film thereof, and a layer of bead-like and transparent glass particles embedded on top of the transparent plastic film via the transparent adhesive glue thereof;
whereby, the attachment piece combined with the diagram/letter-printed article can reflect light beams sending out from a light source via the bead-like and transparent glass particles thereof to give out warning signals for safety in case of a dark place or nighttime; under normal light, the bead-like and transparent glass particles thereof can penetrably reveal the diagrams or letters of the diagram/letter-printed article thereof.

2. The attachment piece in combination with a diagram/letter-printed article as claimed in claim 1 wherein the transparent film of the attachment piece is made of plastics.

3. The attachment piece in combination with a diagram/letter-printed article as claimed in claim 1 wherein the transparent particles of the attachment piece are best bead-like in shape.

4. The attachment piece in combination with a diagram/letter-printed article as claimed in claim 1 wherein the transparent bead-like particles of the attachment piece are made of glass.

5. The attachment piece in combination with a diagram/letter-printed article as claimed in claim 1 wherein the diagram/letter-printed article is made of a woven fabric, cloth, leather, or something of the like.
